(19) United States
(12) Patent Application Publication
(10) Pub. No.: US 2002/0044995 A1
(43) Pub. Date: Apr. 18, 2002

(54) Coolant

(76) Inventor: Andre Marton, Kempten (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/976,146

(22) Filed: Oct. 15, 2001

(30) Foreign Application Priority Data
Oct. 13, 2000 (DE) 100 50 916.9

(51) Int. Cl. A23L 3/36

(52) U.S. Cl. 426/414; 252/70; 426/524

(57) ABSTRACT

The invention relates to the use of cooled alcohol as coolant. Salt of the alkali metals, beryllium group or alkaline-earth metals, in particular common salt, is added to said coolant.

### BACKGROUND OF THE INVENTION

The present invention relates to a coolant comprising alcohol and to the use of cooled alcohol, in particular distilled spirits or ethanol, alkanes, acetic acid esters, in particular butyl acetate, ethyl acetate or acetone, or a mixture thereof, as coolant for the freezing or surface freezing of foods such as slabs of sausage or cheese.

A process and system for the freezing of meat is described in International Patent Application wo 99/21429. In this application, the meat is introduced into a coolant in the form of ice slush or brine at a temperature below 0° C. The aim of this document is to remove a certain amount of thermal energy from the meat, the meat being precooked.

European Patent No 0 290 696 describes a process for the deep freezing of foods in which the foods are cooled using a deep-cooling solution based on ethanol.

The use of alcohol as a coolant for foods has already been described in German Patent Application 198 60 442 in the name of the present Applicant's predecessor in title. Reference is made to the entire contents of that application here. In contrast to the otherwise known use of liquid carbon dioxide or nitrogen for cooling foods, the use of cooled alcohol offers a much more cost-effective variant.

To prevent the alcohol from being accidentally consumed, the addition of a food-compatible denaturing agent, in particular lactic acid and/or acetic acid to the coolant has been described in the state of the art.

It is the object of the invention further to develop the use of the cooled alcohol as coolant and to add it to a different denaturing agent which is optionally also more cost-effective.

### BRIEF SUMMARY OF THE INVENTION

The invention provides use of cooled alcohol, mixed with a salt selected from the group consisting of the alkali metals, beryllium group and alkaline-earth metals, as coolant for the freezing or superficial freezing of foods such as slabs of sausage or cheese.

The invention further provides a coolant for the freezing or superficial freezing of foods such as slabs of sausage or cheese, said coolant containing alcohol wherein a salt selected from the group consisting of the alkali metals, beryllium group and alkaline-earth metals, is added to said coolant.

Said alcohol is preferably an alcohol selected from the group consisting of distilled spirits, ethanol, alkanes and acetic acid esters or a mixture thereof. Where said alcohol is an acetic acid ester, said acetic acid ester is preferably an acetic acid ester selected from the group consisting of butyl acetate, ethyl acetate and acetone.

Said salt is preferably common salt (sodium chloride).

### DETAILED DESCRIPTION OF THE INVENTION

The use of inorganic salts based on the elements of the alkali or alkaline-earth metals is a cost-effective option for providing a denaturing agent for ethanol or alcohol. At the same time, common salt is safe for use in foods as the use of common salt as a curing agent for food preservation is well known and salt is also used to develop the taste of the product. However, the same also applies to the other salts derivable from the aforementioned chemical groups.

Advantageous properties of the substances may be combined with one another by combining common salt (NaCl) with ethanol. The disinfecting actions of alcohol is dealt with in detail, in particular, in the aforementioned document. The disinfecting action of alcohol will accordingly be combined with the taste of salt which is neutral in taste and should be appropriately allowed for during production, and the preserving action of the salt utilised. Common salt is a naturally occurring salt which is now obtained in a very economical and environmentally acceptable manner. At the same time, it can be ensured by an appropriate concentration of common salt or of the aforementioned salts in the alcohol or in the coolant, that the alcohol will not be consumed accidentally. It should be noted that, in particular, distilled spirits or ethanol in high concentration can be harmful to the health.

It has been found that even small concentrations of salt in the coolant prevent enjoyable consumption of the coolant. It has been found, in particular with common salt, that a proportion of about 3%, based on the weight of the total coolant, is sufficient. Depending on the intensity of the taste of other salts, however, a higher or a lower concentration may also be required, which is why a range of about 0.5% to 10.0% (based on the respective weight) in proportion of salt in the coolant has proven desirable. The use of about 3%, based on weight, of salt can easily be allowed for in the food recipe, and does not lead to a perceptible change (salty taste) in the food.

In contrast to the state of the art in International Patent Application WO 99/21429, a relatively small proportion of common salt is proposed here. The use of common salt as a coolant mixture, for example for the thawing of roads, is well known, but brine also solidifies at about −15° C. to −22° C., depending on the salt conformation. It is favourable for rapid processing, in particular for surface cooling, if a medium which is still liquid even at lower temperatures is made available. For this reason, the use of alcohol is proposed according to the invention because it remains liquid at much lower temperatures. The salt concentration is sufficient reliably to prevent the enjoyable consumption of alcohol.

Preferably the coolant contains between 50% and 90%, more preferably about 70% of alcohol (based on the total weight). The freezing point of the coolant and therefore also the range within which the food can be cooled may be adjusted through the level of the alcohol concentration. At the same time it should be noted that the risk of explosion obviously also increases with the high concentration of alcohol, which is why distilled water is added to the coolant to reduce the risk of explosion. It is a further advantage that the salt, in particular common salt, dissolves better in water than in alcohol.

It has been found that favourable results are achieved if the coolant has a temperature of −40° C. to −10° C., preferably from −30° C. −20° C. The mixture of the coolant is therefore selected in such a way that the desired temperature range is made available, the coolant still being liquid in this temperature range. If it is found that the alcohol concentration used has a freezing point well below the desired working temperature range, the concentration of alcohol may be reduced appropriately and the concentration of water or distilled water increased appropriately. The application according to the invention or the use of alcohol and the appropriate selection of the concentration results in a substantially liquid coolant, even with a low working temperature range. This at the same time ensures that the alcohol concentration is not too high or is sufficiently low to prevent the risk of explosion of the inflammable alcohol.

A flavouring, for example kirsch or Bordeaux wine, may be added to the coolant to improve the taste of the food. The alcohol content of these flavourings evaporates during processing of the food so only the flavourings remain in the food. However, it is also possible to use essential oils, smoke essences or other flavourings which may be alcoholic or water-soluble.

The invention relates not only to the use of alcohol as coolant but similarly also claims a coolant as substance with the appropriate recipe. This coolant can have a recipe (composition) of the type described here in conjunction with the use of alcohol.

The invention also relates to a process for slicing foods such as slabs of sausage or cheese which are lying, in particular, on a support and are sliced by a cutting blade. One or more foods may be sliced simultaneously by the cutting blade. The application of the coolant also proposed according to the invention or the use of alcohol according to the invention allows the slab of food to be frozen at least on the surface and fraying of the edge regions of the food otherwise observed to be safely and reliably avoided. The process according to the invention combines various advantages. The coolant recipe is selected so as to utilise the disinfecting action of the alcohol. The application of inorganic salts, in particular common salt, on the one hand leads to reliable protection from alcohol consumption and on the other hand can be allowed for without difficulty in terms of taste in the recipe of the slab of food. Both substances, in appropriate concentrations, may be used in the food. The application of this cooling process as the process step preceding the slicing process safely and reliably prevents the severed slices from fraying in the edge region or waste from being created. The use proposed according to the invention or the coolant is also inexpensive as the otherwise normal distilled spirit taxes do not have to be applied to this recipe. This results in a corresponding cost benefit when using this coolant or when carrying out the different process described here.

At the same time, the process according to the invention proposes a cooling process which takes place relatively rapidly because the colder the coolant, the faster cooling is.

The solution according to the invention not only reduces the wastage in the cutting process according to the invention but also simultaneously accelerates the entire process. These advantages occur simultaneously and create the synergy of the measures employed.

In a preferred development of the process according to the invention it is proposed that the coolant is substantially liquid. Depending on its concentration (relative to distilled water) the alcohol used has a freezing point of down to −60° C. (with an ethanol concentration of about 75%). If the coolant is liquid, it surrounds the product to be cooled, i.e. the slab of food, very rapidly during the immersion process. At the same time, the homogeneous liquid allows relatively rapid distribution of the thermal energy removed from the slab of food in the coolant. It has been observed when using ice slush, on the other hand, that although higher thermal energy can be removed with the different phases (liquid and solid) because the thawing heat can be utilised at the phase transistion of the ice, the heat transfer in the ice and water mixture is poorer. At the same time, an article to be cooled is immersed with greater difficulty in a liquid mixed with ice as the viscosity of this liquid is much higher than in the coolant according to the invention. This also impedes rapid cooling, in particular of the edge region. The invention also relates to a process for slicing and packaging foods. According to the invention, it is proposed that the above-described process steps for slicing the food, which are substantially characterised in that the food is immersed into the coolant according to the invention and then sliced, is followed by a packaging step during which the food is packaged in a packaging station afterwards. Sliced food products are usually packaged, for example, in thermoforming vacuum packaging machines or the like. They are wrapped with plastic sheeting, the packaging is then either evacuated or subjected to a protective gas atmosphere and the packaging is then molded or sealed. Owing to the disinfecting action of the alcohol used, however, a considerable increase in the durability of packagings produced by the process according to the invention is now observed. It has been found in individual cases that the durability is extended by up to 12 days. This is due to the disinfecting action of the alcohol which leads to a drastic reduction in the number of germs in the food. However, if the initial number of germs existing in the packaging is substantially reduced, the food only becomes unserviceable at a later stage because a corresponding critical number of germs is formed in the packaged product again only, after a prolonged period. A further advantage is that a proportion of the alcohol initially penetrates into the edge region of the slab of food and is then evaporated again during packaging or afterwards in the packaging and thus influences the vacuum or the protective gas atmosphere.

The claims filed now with the application and subsequently are attempts at wording without prejudice to the attainment of further protection.

The referrals mentioned in the dependent claims relate to the further development of the subject of the main claim by the features of the respective sub-claim. However, these should not be interpreted as a waver of the obtaining of independent subjective protection for the features of the related sub-claims.

Features which have only hitherto been disclosed an the description may be claimed in the course of the proceedings as having significance essential to the invention, for example as a restriction from the state of the art.

1. Use of cooled alcohol, mixed with a salt selected from the group consisting of the alkali metals, beryllium group and alkaline-earth metals, as coolant for the freezing or superficial freezing of foods such as slabs of sausage or cheese.

2. Use of cooled alcohol according to claim 1, wherein said alcohol is an alcohol selected from the group consisting of distilled spirits, ethanol, alkanes and acetic acid esters or a mixture thereof.

3. Use of cooled alcohol according to claim 2 wherein said acetic acid ester is an acetic acid ester selected from the group consisting of butyl acetate, ethyl acetate and acetone.

4. Use of cooled alcohol according to claim 1, wherein said salt is common salt.

5. Coolant for the freezing or superficial freezing of foods such as slabs of sausage or cheese, said coolant containing alcohol wherein a salt selected from the group consisting of the alkali metals, beryllium group and alkaline-earth metals, is added to said coolant,

6. Coolant according to claim 5 wherein said coolant contains an alcohol selected from the group consisting of distilled spirits, ethanol, alkanes, acetic acid ester, or a mixture thereof.

7. Coolant according to claim 6 wherein said acetic acid ester is an acetic acid ester selected from the group consisting of butyl acetate, ethyl acetate and acetone.

8. Use of alcohol according to claim 1 wherein distilled water is added to said coolant.

9. Coolant according to claim 5 wherein distilled water is added to said coolant.

10. Use of alcohol according to claim 8 wherein said coolant contains between 50% and 90% by weight of alcohol, based on said coolant.

11. Use of alcohol according to claim 10 wherein said coolant contains about 70% by weight of alcohol, based on said coolant.

12. Coolant according to claim 9 wherein said coolant contains between 50% and 90% by weight of alcohol, based on said coolant.

13. Coolant according to claim 12 wherein said coolant contains about 70% by weight of alcohol, based on said coolant.

14. Use of alcohol according to claim 1 wherein between 0.5% and 10.0% by weight of salt, based on the weight of said coolant are added to said coolant.

15. Use of alcohol according to claim 14 wherein 3.0% by weight of salt, based on the weight of said coolant are added to said coolant.

16. Coolant according to claim 5 wherein between 0.5% and 10.0% of salt, based on the weight of said coolant are addded to said coolant.

17. Caoolant according to claim 16 wherein 3.0% by weight of salt, based on the weight of said coolant are added to said coolant.

18. Use of alcohol or coolant according to claim 1 wherein said coolant has a temperature of −40° C. to −10° C.

19. Use of alcohol or coolant according to claim 18, wherein said coolant has a temperature of −30° C. to −20° C.

20. Use of alcohol according to claim 1 wherein a flavouring is added to said coolant.

21. Use of alcohol according to claim 20 wherein said flavouring is in the form of an alcoholic beverage

22. Use of alcohol according to claim 20 wherein said flavouring is in the form of an essential substance.

23. Use of coolant according to claim 5 wherein a flavouring is added to said coolant.

24. Use of coolant according to claim 23 wherein said flavouring is in the form of an alcoholic beverage

25. Use of coolant according to claim 23 wherein said flavouring is in the form of an essential substance.

26. Process for slicing foods such as slabs of sausage or cheese, which is sliced by a cutting blade and the food is cooled prior to slicing wherein the food is immersed into a coolant according to claim 5 and is superficially frozen.

27. Process according to claim 27 wherein the coolant is substantially liquid.

28. Process for the cutting and packaging of foods, wherein the process steps according to claim 26 are followed by a packaging step during which the cut food product is packaged in plastic sheeting under vacuum or a protective atmosphere.
